(19) United States
(12) Patent Application Publication
(10) Pub. No.: US 2011/0100819 A1
(43) Pub. Date: May 5, 2011

(54) PROCESS FOR THE TREATMENT OF THE AQUEOUS STREAM COMING FROM THE FISCHER-TROPSCH REACTION

(75) Inventors: Roberta Miglio, Oleggio (Novara) (IT); Renzo Bignazzi, Legnano (Milano) (IT); Lino Carnelli, Carbonate (Como) (IT)

(73) Assignee: ENI S.p.A., ROMA (IT)

(21) Appl. No.: 12/863,289

(22) PCT Filed: Jan. 14, 2009
(86) PCT No.: PCT/EP09/00391

§ 371 Date: Jan. 20, 2011

(30) Foreign Application Priority Data
Jan. 18, 2008 (IT) MI2008A000080

(51) Int. Cl. B01D 61/44; C25B 7/00; B01D 61/42

(52) U.S. Cl. 204/537; 204/544

(57) ABSTRACT

The present invention relates to a process for the treatment of the aqueous stream coming from the Fischer-Tropsch reaction which comprises: —feeding of the aqueous stream containing organic by-products of the reaction to a distillation or stripping column; —collection from the column of a distillate enriched in alcohols having from 1 to 8 carbon atoms and other possible volatile compounds; feeding of the aqueous stream containing the acids leaving the bottom of the distillation column to an electrodialysis cell and the production of two outgoing streams: —an aqueous stream (i) enriched in organic acids having from 1 to 8 carbon atoms; —a purified aqueous stream (ii) with a low acid content.

The present invention relates to a process for the treatment of an aqueous stream coming from the Fischer-Tropsch reaction.

More specifically, the invention relates to a process for the treatment of an aqueous stream coming from the Fischer-Tropsch reaction by the combination of a distillation/stripping step and one or more electrodialysis steps which allows a stream concentrated in C₁-C₈ organic acids, a mixture of C₁-C₆ alcohols with a reduced water content and a stream of water purified to the desired quality, to be obtained.

The Fischer-Tropsch technology for preparing hydrocarbons from mixtures of gases based on hydrogen and carbon monoxide, conventionally known as synthesis gas, is known in scientific literature. A summary of the main works on the Fischer-Tropsch synthesis is contained in the Bureau of Mines Bulletin, 544 (1955) entitled “Bibliography of the Fischer-Tropsch Synthesis and Related Processes” H. C. Anderson, J. L. Wiley e A. Newell.

The process for the production of liquid hydrocarbons with the Fischer-Tropsch reaction generates an amount, by weight, of water which is greater than the total amount produced of hydrocarbons, following the production of a mole of water for each mole of CO converted into hydrocarbons.

Before purification, the reaction water (co-produced water), is subjected to preliminary separations. Typically it passes through a three-phase separator from which an organic condensate is obtained, together with a vapour phase and the aqueous phase which still contains organic compounds dissolved and in suspension and which is preferably treated in a coalescence filter.

The water thus separated remains contaminated by hydrocarbon compounds, typically less than 1,000 ppm, and oxygenated compounds, soluble in water. The amount of contaminants depends on the catalyst and on the reaction conditions, in particular temperature and pressure. The amount of oxygenated compounds on the whole increases with an increase in the reaction temperature, more significantly the group of acids.

The main oxygenated contaminants are light alcohols such as methanol and ethanol, indicatively present in an amount of from 0.5 to 5% by weight. Heavier alcohols are also present in a lower amount (for example, propanol, butanol, pentanol) and other oxygenated compounds, such as aldehydes (e.g. acetaldehyde, propionaldehyde, butyraldehyde), ketones (acetone, methylpropyl ketone) and acids (e.g. formic, acetic, propionic, butyric, isobutyric, valeric, hexanoic, heptanoic, octanoic acid), the latter indicatively at concentrations lower than 1.5%. The amount of compounds present, within each group, decreases with an increase in the molecular weight, and compounds with up to 25 carbon atoms are included. The water can also contain small amounts of nitrogenated and sulfurated compounds deriving from the feedstock used, in addition to traces of metal coming from the reactor. The metals can also be present in the form of suspended solids.

The stream as such does not have a commercial value and cannot be disposed of as such, the oxygenated compounds (acids), moreover, give corrosive properties, the hydrocarbons have the tendency to form foams (foaming).

Rainwater or other kinds of service water present in the production site can be added to the co-produced water.

A water treatment system is therefore necessary for allowing the water within the FT process to be re-used, for example as cooling water in the synthesis section, or for its disposal outside or for other additional uses, such as irrigation water or drinking water.

The treatment or combination of treatments on the co-produced waters is determined by the restrictions imposed by the final use of the water and of the organic compounds present therein.

The water treatment system is normally of the biological type which can be preceded by a treatment, typically stripping/distillation, to remove the most volatile compounds. The water deriving from the biological treatment is then normally subjected to a further finishing treatment to remove the solids and, if necessary, also the residual salts from the biological treatment. An approach of this type is suggested for example in U.S. Pat. No. 7,166,219, U.S. Pat. No. 7,150,831, U.S. Pat. No. 7,153,392 (SASOL) and WO 2005113426 (STATOIL—PETROLEUM OIL & GAS CORP SOUTH AFRICA).

When the water is treated by means of a biological process, the organic compounds contained therein are degraded to CO₂ and H₂O or CO₂, CH₄ and H₂O and the dosage of the chemicals required by the biological process, whether it be of the aerobic or anaerobic type, leads to the production of a sludge, which indicatively ranges from 0.05-0.5 kg per kg of biodegraded COD.

Biological treatment is generally costly for the chemicals (for example urea, phosphates), which must be dosed and for the high volumes of the tanks/treatment reactors, as the biological reaction times are in the order of hours, and for the air to be insufflated when aerobic treatment is used. Another drawback of the biological treatment is that the organic compounds present in the water cannot be upgraded.

Should the organic compounds present in the co-produced water be upgraded, instead of biodegraded, a physico-chemical treatment must be applied. In U.S. Pat. No. 6,462,097 (IFP-ENI), for example, an adsorption step on activated carbons is envisaged, after the stripping treatment, the regeneration stream of activated carbons, rich in organic compounds can then be re-fed to the synthesis reactor. Similar suggestions are also provided in U.S. Pat. No. 6,225,358 (SYNTROLEUM CORP), U.S. Pat. No. 5,053,581, U.S. Pat. No. 5,004,862 (EXXON), in which the organic compounds, for example C₁-C₆ alcohols, present in the co-produced water are potentially returned and therefore upgraded to simple molecules such as COx/H₂ (syngas).

Other types of treatment, of the physico-chemical kind, allow one or more streams concentrated in organic compounds to be separated, contemporaneously with the production of water purified to the desired degree.

It is possible to separate, by distillation, for example, as described in US 2004 0262199 (SASOL) and in Italian patent application MI07A001209 (ENI), a prevalently alcohol stream with a content of non-acid compounds (NAC) ranging from 55% to a maximum of 85%. This stream can be used as fuel or alternatively it can be further processed to recover the valuable products.

The formation, by physico-chemical treatment, of one or more streams concentrated in various groups of organic compounds, contemporaneously with the production of water purified to the required degree, is described for example in U.S. Pat. No. 7,153,432 B2 (SASOL) which proposes a process with at least two steps, the first a distillation step and the second a separation step with membranes, plus, if necessary, other accessory steps for bringing the purified water to the required degree of purity. This process, however, suffers from the disadvantage deriving from the practically stoichiometric consumption of base (for example NaOH) and the production of a stream concentrated in salts of the corresponding carboxylic acids.

It has now been found that electrodialysis can be successfully applied for separating a stream concentrated in acids from the aqueous stream coming from the Fischer-Tropsch reaction and also for the possible recovery of the base and of the acids from the stream of salified acids.

In particular, it has been found that by the original combination of two treatments of the physico-chemical type, such as distillation and electrodialysis, the separation can be easily and conveniently effected, of a stream concentrated in alcohols and a stream concentrated in acids from the co-produced water in the Fischer-Tropsch synthesis with the contemporaneous production of water purified to the desired degree. The purified water can be of a suitable quality for its re-use in the same process or for use in agriculture or it can be disposed of as surface water, according to law legislations.

In accordance with this, an object of the present invention relates to a process for the treatment of an aqueous stream coming from the Fischer-Tropsch reaction which comprises:

feeding of the aqueous stream containing organic by-products of the reaction to a distillation or stripping column;

collection from the column of a distillate enriched in alcohols having from 1 to 8 carbon atoms and other possible volatile compounds;

feeding of the aqueous stream containing the acids leaving the bottom of the distillation column to an electrodialysis cell and the production of two outgoing streams:

an aqueous stream (i) enriched in organic acids having from 1 to 8 carbon atoms;

a purified aqueous stream (ii) with a low acid content.

The Fischer-Tropsch synthesis can be carried out as described in the U.S. Pat. No. 6,348,510.

On the basis of the specific necessities for purification (final use), additional preliminary, intermediate or final steps, can also be envisaged, such as filtration or contact with ion exchange resins for example of the chelating type.

The distillate, enriched in alcohols, has an overall alcohol concentration within the range of 25-75%; the aqueous stream (i) has a concentration of organic acids greater than 4% or even more preferably >6%, the aqueous stream (ii) has a concentration of acids lower than 100 ppm.

The co-produced water in the Fischer-Tropsch reaction is generally first subjected to distillation and the stream at the bottom of the distillation is fed to electrodialysis.

Alternatively, the co-produced water can be first fed to the electrodialysis cell and the distillation can be effected on the purified aqueous stream (ii) with a low acid content leaving the electrodialysis cell.

The electrodialysis treatment can be configured according to a conventional module (CED) comprising alternating anionic and cationic membranes to form two chambers: one in which the concentration of the acids is obtained (CSC Concentrated Solution Chamber) and one in which the solution of acids is diluted (DSC Dilute Solution Chamber), in addition to the anode and cathode chamber in which there is present a washing solution of the electrodes (ERS Electrode Rinsing Solution).

A basic module can also contain more than two alternating dilution and concentration chambers of the solution.

Alternatively, the electrodialysis treatment can be configured with bipolar membranes alternating with anionic membranes (EDBM).

In this configuration, the chamber in which the dilution of the solution (DSC) is effected is that between the anionic exchange membrane and the anionic exchange layer of the bipolar membrane.

In both of the above alternatives, the treatment is not capable of removing the amount of weak acids which remain in undissociated form with the pH and concentration of the diluted solution.

The residual level of acids in the diluted solution is brought to the desired value, with the current density, linear flow rate, residence time and possibly limiting the concentration of acids in the other chamber.

The more concentrated the acids, the higher their residual value will be in the purified solution.

In order to obtain water with a higher purification degree, NaOH can be added to the solution in which the acids are present so as to favour the dissociation of the acids and migration of the carboxylate as anion from the chamber in which the solution is diluted towards that in which the concentrated solution is produced.

The preferred configuration in this case is that in which a conventional electrodialysis cell (CED) is conducted to concentrate the solution, followed by a second electrodialysis cell of the concentrated solution with bipolar membranes (EDBM) to obtain a solution of concentrated acids and a solution of NaOH to be recirculated to the first electrodialysis cell.

For illustrative purposes, the bipolar electrodialysis unit can contain alternating layers, starting from the anode (+) of bipolar membranes (AC) and cationic membranes (C) in a two-chamber configuration (EDBM2C) in which the solution of salified acids is fed to one and the acid is formed, in the other chamber the base is formed.

Alternatively, the electrodialysis unit can contain alternating layers, starting from the anode (+), of bipolar membranes (AC), anionic (A) and cationic membranes (C) in a three-chamber configuration (EDBM3C), in one of which the acid is formed, the base is formed in another and the solution to be treated is fed to the other.

The bipolar membranes allow the splitting of the H₂O into hydrogen and hydroxide ions. In the chamber between the cationic exchange membrane and the anionic exchange part of the bipolar membrane, the formation of acids is obtained (also called DSC), vice versa in the chamber between the cationic exchange membrane and the cationic exchange part of the bipolar membrane, the formation of the base, NaOH is obtained (also called CSC).

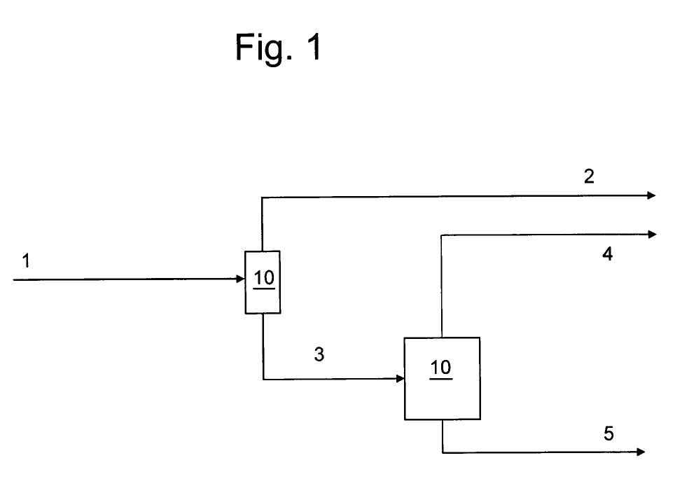

With reference to FIG. 1, the co-produced water in the FT synthesis (stream 1) is fed to a distillation column (10). At the head of the distillation column, it is possible to separate a stream concentrated in alcohols (stream 2). The bottom of the distillation column (stream 3), in which the carboxylic acids are already partly concentrated, is fed to an electrodialysis treatment (20). A practically purified water stream (stream 5) and a stream concentrated in acids (stream 4) are separated from the electrodialysis treatment.

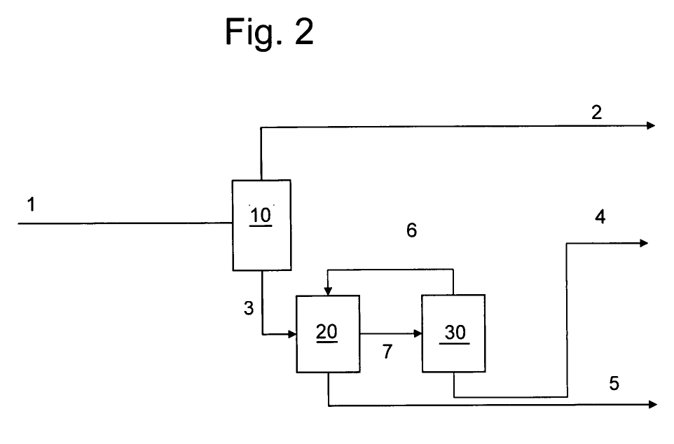

With reference to FIG. 2, the purification degree of the water can be further increased, the water co-produced in the FT synthesis (stream 1) is fed to a distillation column (10). At the head of the distillation column, it is possible to separate a stream concentrated in alcohols (stream 2). The bottom of the distillation column (stream 3), in which the carboxylic acids are already partly concentrated, is fed to an electrodialysis treatment (20). A stream of NaOH (stream 6) is introduced into the electrodialysis treatment. A practically purified water stream (stream 5) and a stream concentrated in salified acids (stream 7) are separated from the electrodialysis treatment. The stream of salified acids enters a second electrodialysis treatment (30) from which a stream concentrated in acids (stream 4) exits together with a stream of NaOH (stream 6) which is recirculated to the first electrodialysis treatment (20).

The dissociation of the acids can also be obtained with the addition of other basic solutions, such as for example an aqueous solution of NH₄OH.

The solution can have a concentration of acids of even over 15% by weight, it is preferable to re-obtain the solution concentrated in acids and the relative base solution starting from solutions with a concentration >4%, preferably >6%. The conversion of the salified acids in the respective acids and bases is generally >95%.

Membranes which are suitable for the purpose are those commercially available with a high permselectivity, low electric resistance, high mechanical and chemical stability, for example anionic and cationic exchange membranes of Asahi Glass Co. (AMV, CMV), of Tokuyama (Neosepta AMX and CMX, AM-1 and AM-1), Tokuyama bipolar membranes (BP-1), Aqualitics (BP).

As is known for expert in the field, the electrodialysis treatment can be managed with other configurations obtaining different removal efficiencies, for example ion exchange resins or conductive spacers can be introduced into chambers with a low ion content (DSC) to increase the conductivity of the solution.

The current densities used are typically 10-50 mA/cm2 of the surface of the membranes, the current efficiencies (ratio between the number of ions which pass through with respect to the current of the cell) are mainly linked to the concentration of the acids to be obtained in addition to the other working variables. There is a maximum efficiency in relation to the current density used. In the hypothesis of concentrating the acids within the range of 4-6%, efficiencies >80%, and even >95%, can be obtained.

Suitable temperatures are those lower than 60° C., preferably lower than 50° C.

There are no restrictions on the concentration of the acid streams which can be treated even if, within the scope of the present invention, solutions with an acid content lower than 1.5% by weight are preferred, even better from 500 to 1,500 ppm by weight. The presence of alcohols or hydrocarbons at an overall level which is lower than 5% does not significantly interfere with the removals.

The dimensioning and the number of lines in series and/or parallel and the possibility of recirculating internal streams is obtained, as is known in the field, mainly on the basis of the concentration of acids in the bottom stream and the residual acidity content to be obtained in the purified stream.

An illustrative and non-limiting example is provided hereunder for a better understanding of the present invention and for its embodiment.

### EXAMPLE 1

The water which is separated by decanting from the FT synthesis effluent, carried out as disclosed in U.S. Pat. No. 6,348,510 (IFP-ENI), is fed to a distillation column. The composition of the feedstock to the distillation column is indicated in Table 1 column A. The stream leaving the head of the distillation column has the composition specified in Table 1 column B.

The residue of the distillation column, whose analysis, effected by means of gas chromatography and ionic chromatography, is indicated in Table 1, column C, is then fed to an electrodialysis cell of the conventional type (CED).

The cell has a volume equal to about 500 ml.

Membranes having an area of 15 cm×15 cm, with an effective area of 100 cm², are assembled in the cell. The membranes are spaced with a polypropylene lattice to maintain a span between the adjacent membranes of 1.5 mm. Anionic and cationic exchange membranes were used, having a thickness of 0.20 mm and an exchange capacity of 1.8 meq/g of anhydrous membrane. Two repeated units are assembled, starting from the anode (+), C, A, C, A, C to form two DSC chambers and two CSC chambers in addition to the anode and cathode chamber.

The process is carried out batchwise at room temperature.

The solution at the bottom of the column was circulated for a time sufficient for reaching an equilibrium condition by means of a peristaltic pump in a circuit which comprises a polypropylene container and the DSC chambers, for an overall liquid hold-up of 6 kg. The same solution was contemporaneously re-circulated through a second container and in the CSC chambers, for an overall liquid hold-up of 500 g. The containers of the two solutions are placed on a balance to monitor the weight variations of the two recirculating solutions. The anode and cathode chambers are subjected to the recirculation of a solution of H₂SO₄ 0.5%.

Once a stable initial conductivity value had been reached in the two circulating solutions, indicatively of 350 microS/cm, the direct current generator was switched on and regulated to obtain a current of 2 A, corresponding to an applied current density of 20 mA/cm².

During the treatment over a period of 8 hours, liquid samples were collected from the various chambers of the cell and analysis of the carboxylic acids was effected by means of ion chromatography.

The final result is indicated in Table 1 columns D and E.

TABLE 1

| | | B | C | | E |
|---|---|---|---|---|---|
| | A | Alcohol | Column | D | Acid |
| | Column | concentrated | bottom | Purified | concentrated |
| | inlet | stream | stream | stream | stream |
| Conductivity | | | 355 | | |
| (micronS/ | | | | | |
| cm) | | | | | |
| pH | | | 3.4 | 4.0 | |
| Alcohols | | | | | |
| (% w/w) | | | | | |
| C₁H₄O₁ | 2.46 | 41.19 | 0.004 | 0.001 | |
| C₂H₆O₁ | 0.8 | 13.56 | 0.001 | | |
| C₃H₈O₁ | 0.34 | 5.73 | 0.0008 | | |
| C₄H₁₀O₁ | 0.19 | 3.20 | <0.0005 | | |
| C₅H₁₂O₁ | 0.08 | 1.29 | | | |
| C₆H₁₄O₁ | 0.02 | 0.35 | | | |
| Acids (ppm): | | | | | |
| C₁H₂O₂ | | | 184 | 3 | 2396 |
| C₂H₄O₂ | | | 705 | 34 | 8886 |
| C₃H₆O₂ | | | 129 | 55 | 1028 |
| C₄H₈O₂ | | | 123 | 57 | 925 |
| C₅H₁₀O₂ | | | 5 | 5 | 5 |
| C₆H₁₂O₂ | | | 1 | 1 | 1 |
| total | | | 1147 | 155 | 13241 |

1. A process for the treatment of the aqueous stream coming from the Fischer-Tropsch reaction which comprises:
feeding of the aqueous stream containing organic by-products of the reaction to a distillation or stripping column;
collection from the column of a distillate enriched in alcohols having from 1 to 8 carbon atoms and other possible volatile compounds;
feeding of the aqueous stream containing the acids leaving the bottom of the distillation column to an electrodialysis cell and the production of two outgoing streams:
an aqueous stream (i) enriched in organic acids having from 1 to 8 carbon atoms;
a purified aqueous stream (ii) with a low acid content.

2. The process according to claim 1, wherein the distillate enriched in alcohols has an overall alcohol concentration within the range of 25-75%; the aqueous stream (i) has a concentration of organic acids higher than 4%.

3. The process according to claim 2, wherein the aqueous stream (i) has a concentration of organic acids >6%.

4. The process according to claim 1, wherein the aqueous stream containing organic by-products is first fed to the electrodialysis cell and the aqueous stream (ii) leaving the electrodialysis cell is fed to the distillation column.

5. The process according to claim 1, wherein the electrodialysis cell is configured according to a conventional module comprising alternating anionic and cationic membranes to form two chambers: one in which the concentration of acids is obtained and one in which the dilution of the solution of acids is obtained, in addition to the anode and cathode chamber in which a washing solution of the electrodes is present.

6. The process according to claim 5, wherein the module also contains more than two alternating dilution and concentration chambers of the solution.

7. The process according to claim 1, wherein the electrodialysis cell is configured according to a module comprising bipolar membranes alternating with anionic membranes.

8. The process according to claim 1, wherein a basic solution is introduced into the electrodialysis cell and a practically purified aqueous stream is separated together with a stream concentrated in salified acids which is fed to a second electrodialysis cell from which a stream concentrated in acids exits together with a base stream which is recirculated to the first electrodialysis cell.

9. The process according to claim 8, wherein a basic solution is an aqueous solution of NaOH or NH₄OH.

10. The process according to claim 8, wherein the stream concentrated in acids leaving the second electrodialysis cell has a concentration of acids higher than 15% by weight.

11. The process according to claim 5, wherein current densities of 10-50 mA/cm² of membrane surface are used.

12. The process according to claim 1, wherein the aqueous stream containing acids fed to the electrodialysis cell has a content of acids lower than 1.5% by weight and a content of alcohols or hydrocarbons on an overall level lower than 5%.

13. The process according to claim 1, wherein the electrodialysis cell operates at a temperature lower than 60° C.

14. The process according to claim 13, wherein the electrodialysis cell operates at a temperature lower than 50° C.
